(19) United States
(12) Patent Application Publication
(10) Pub. No.: US 2009/0108568 A1
(43) Pub. Date: Apr. 30, 2009

(54) Adjustable trailer coupler

(76) Inventors: Frank Drake, Wausau, WI (US); Kevin Rabska, Junction City, WI (US); Todd Walstrom, Weston, WI (US)

Correspondence Address: MCDONALD HOPKINS LLC, 600 Superior Avenue, East, Suite 2100, CLEVELAND, OH, 44114-2653, US

(21) Appl. No.: 12/229,838

(22) Filed: Aug. 27, 2008

Related U.S. Application Data
(60) Provisional application No. 61/000,684, filed on Oct. 26, 2007.

(51) Int. Cl. B60D 1/06

(52) U.S. Cl. 280/511

(57) ABSTRACT

A trailer coupler and a method for securing a trailer coupler to a trailer frame are disclosed. The trailer coupler has an attachment portion for securing the trailer coupler to a towing vehicle. The trailer coupler is adjustable and movable from a first position to a second position. The sides of the trailer coupler are at a first angle at the first position and at a second angle at the second position.

### CROSS-REFERENCE TO RELATED APPLICATIONS

This application claims benefit from U.S. Provisional Patent Application No. 61/000,684, entitled “Adjustable A-Frame Coupler,” filed on Oct. 26, 2007, which is hereby incorporated in its entirety by reference.

### FIELD OF THE INVENTION

The present invention is generally related to trailer couplers for use with a trailer.

### BACKGROUND OF THE INVENTION

Cars, trucks, sports utility vehicles, and the like are frequently used as towing vehicles to transport towed vehicles, such as trailers. A trailer, for example, typically has a frame that extends outward so that the frame may be attached to a towing vehicle. A tongue is the portion of the trailer frame extending beyond the trailer body. A trailer coupler is usually attached to the tongue of the trailer. The trailer coupler has a socket portion that is sized and shaped to receive a hitch ball. Accordingly, a hitch ball is mounted to the towing vehicle to permit connection to the trailer coupler. The hitch ball of the towing vehicle removably secures to the trailer coupler to permit the towing vehicle to transport the towed vehicle, such as a trailer and the contents of the trailer, for example boats, other vehicles, ATVs, furniture and other objects.

As is known in the art, there are different designs of trailer couplers available for connecting a trailer tongue to a towing vehicle, such as gooseneck couplers, flat mount couplers, A-frame couplers, and the like. A trailer tongue is usually formed by connecting two pieces of the trailer frame at a predetermined angle. In the industry, the standard angle for a trailer tongue is 50 degrees. As a result, trailer couplers are only designed to connect to the standard 50-degree angle.

FIG. 1 illustrates an example of an A-frame trailer coupler 100 that is known in the prior art. As shown in FIG. 1, the prior art trailer coupler 100 includes two side plates 102, 104 and a top plate 106 to form a shape similar to that of the letter “A.” The top plate 106 is typically a solid piece of material that includes a large hole 110 in which a trailer jack (not shown) may be inserted therethrough. The trailer coupler 100 is a standard trailer coupler only attachable to a trailer tongue having a 50 degree angle. However, at least some trailer tongues have angles different than 50 degrees. As a result, prior art A-frame trailer couplers, such as the trailer coupler 100 is incapable of use with a trailer tongue having an angle different than 50 degrees.

Therefore, there is a need in the art for a trailer coupler capable of connection to trailer tongues having different angles than the standard angle of 50 degrees. In addition, a need exists in the art for a trailer coupler capable of adjustments to angles different than 50 degrees.

### DESCRIPTION OF THE DRAWINGS

Operation of the invention may be better understood by reference to the following detailed description taken in connection with the following illustrations, wherein:

FIG. 1 illustrates a perspective view of a prior art trailer coupler.

FIG. 2A illustrates a perspective view of a trailer coupler in accordance with an embodiment of the invention.

FIG. 2B illustrates a perspective view of a trailer coupler in another embodiment of the present invention.

FIG. 3 illustrates a bottom view of a trailer coupler positioned on a trailer tongue in an unadjusted position in an embodiment of the present invention.

FIG. 4 illustrates a top view of a trailer coupler in an unadjusted position on the trailer tongue of FIG. 3 in an embodiment of the present invention.

FIG. 5 illustrates a bottom view of a trailer coupler in an adjusted position on the trailer tongue of FIG. 3 in an embodiment of the present invention.

FIG. 6 illustrates a top view of a trailer coupler secured to the trailer tongue of FIG. 3 in an embodiment of the present invention.

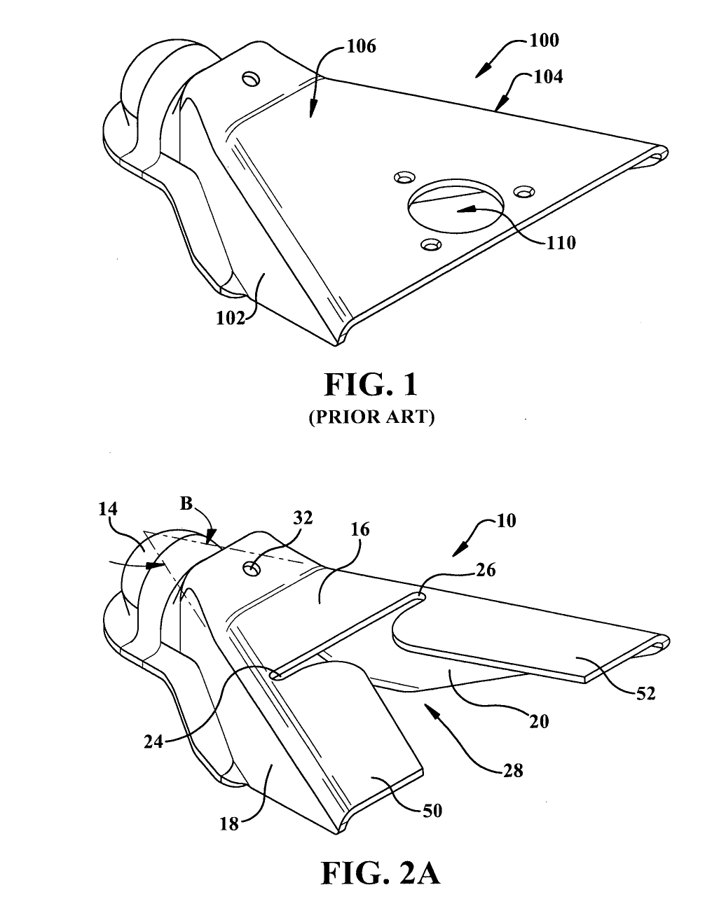

### SUMMARY OF INVENTION

A trailer coupler and a method for securing a trailer coupler to a trailer frame are disclosed. The trailer coupler may have an attachment portion for removably securing the trailer coupler to a towing vehicle. The trailer coupler may have a top plate with a first portion movable with respect to a second portion or vice versa. A first side and a second side may extend from the top plate and form a first angle. The first side and the second side and/or the first portion and the second portion are movable, adjustable and bendable to a second angle that is different than the first angle. As a result, the trailer coupler of the present invention may be adjustable for connection to trailer frames having different angles.

### DETAILED DESCRIPTION OF A PREFERRED EMBODIMENT

While the invention is described herein with reference to an embodiment, the present invention should not be limited only to the embodiment disclosed or discussed. The description of the embodiment herein is illustrative of the invention and should not limit the scope of the invention as described or claimed.

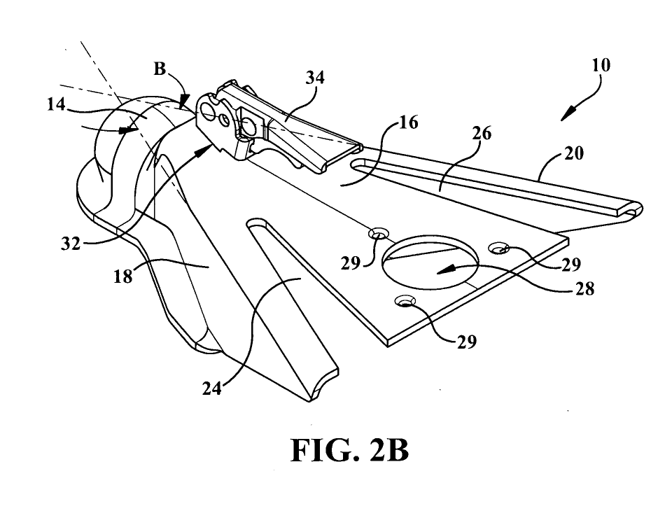

As generally illustrated in FIGS. 2A and 2B, a trailer coupler 10 is provided. Although embodiments of the trailer coupler 10 are shown as an A-frame trailer coupler, the trailer coupler 10 should not be limited as being an A-frame trailer coupler and may be any other type of trailer coupler as will be appreciated by a person having ordinary skill in the art.

The trailer coupler 10 is constructed from a material, such as a material having resilient and durable properties, for example, metals, metal alloys, polymers and the like. In an embodiment, the trailer coupler 10 may be cast or made of a stamped steel, for example, into a singular component. However, the trailer coupler 10 is not limited to any specific material or any specific manner of forming the trailer coupler 10.

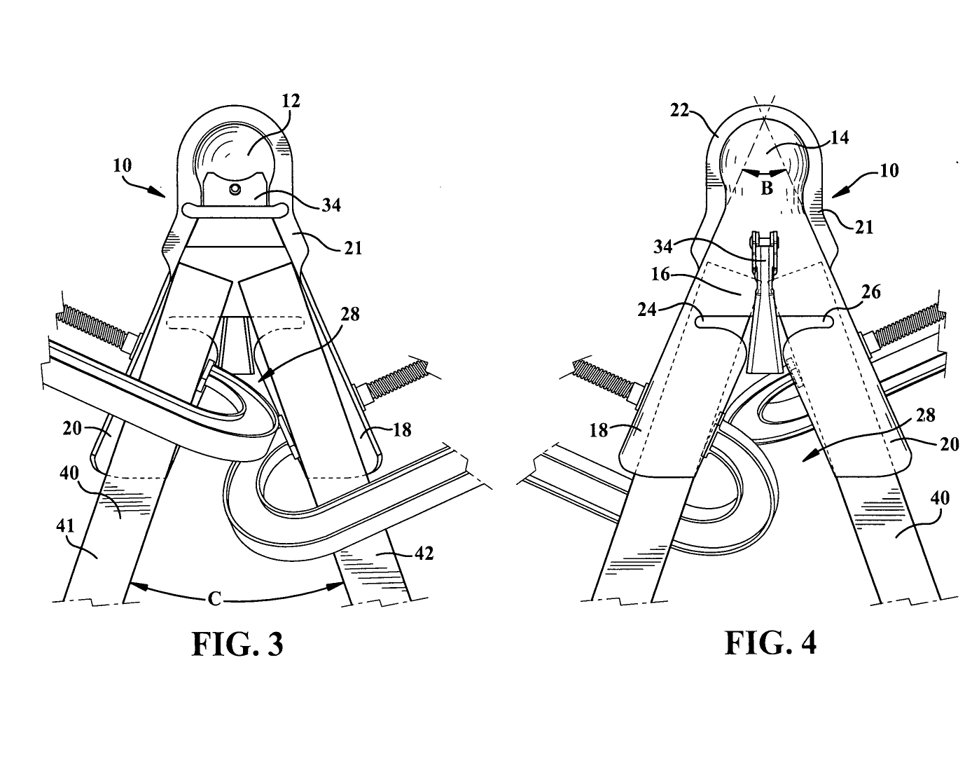

The trailer coupler 10 may have an attachment portion 14 that may be used to secure the trailer coupler 10 to a towing vehicle. For example, the attachment portion 14 may have a socket shape to receive a hitch ball that may be secured to the towing vehicle. In such an embodiment, the attachment portion 14 may have an opening 12, as shown in FIG. 3, that corresponds in size and shape to a hitch ball or other component that may be secured to the towing vehicle. The attachment portion 14 may be other shapes in which to attach to a towing vehicle.

A top plate 16 may extend from the attachment portion 14. The top plate 16 may be shaped to correspond to the shape of a trailer. For example, the top plate 16 may have an a-frame shape to attach to an a-frame trailer. The top plate 16 may have a width defined between a first side 18 and a second side 20. The first side 18 and the second side 20 may extend downward, for example, from the top plate 16. In an embodiment, the first side 18 and/or the second side 20 may be substantially perpendicular to the top plate 16.

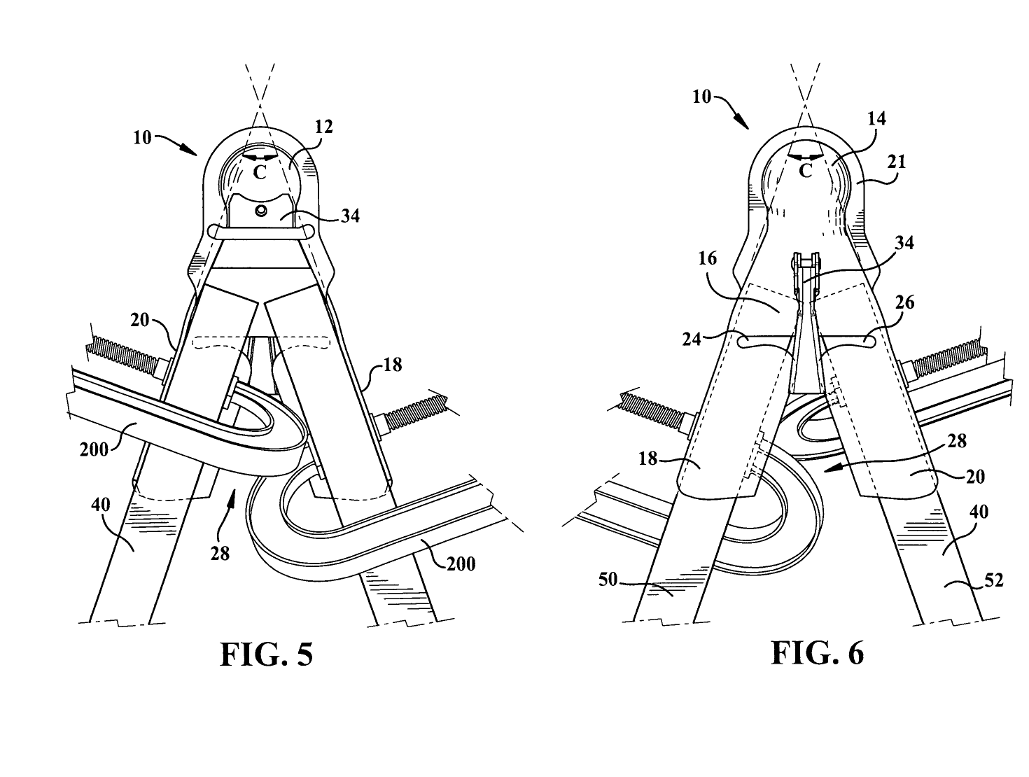

The sides 18, 20 may extend from the top plate 16 to a structural lip 21 at an end of the trailer coupler 10 opposite the top plate 16. The structural lip 21 may extend along a portion of the sides 18, 20 and may aid in strengthening the trailer coupler 10. In an embodiment, shown in FIGS. 3 and 5 the structural lip 21 may extend around the attachment portion 14, such as the opening 12.

An aperture 32 may be located in the top plate 16 of the trailer coupler 10. The aperture 32 may be sized and shaped for attachment to a latching mechanism 34, as shown in FIGS. 2B and 3. The latching mechanism 34 may be used to removably secure the trailer coupler 10 to the towing vehicle, such as to a hitch ball secured to the towing vehicle. For example, the latching mechanism 34 may have a portion adjacent to and/or abutting the opening 12 to lock and unlock the hitch ball of the towing vehicle.

The trailer coupler 10 may have an opening 28 formed in the top plate 16 of the trailer coupler 10. In the embodiment shown in FIG. 2A, the opening 28 may define a first portion 50 and a second portion 52 of the top plate 16. In such an embodiment, the opening 28 separates the first portion 50 from the second portion 52 such that the first portion 50 and the second portion 52 are movable with respect to each other. FIG. 2B illustrates an embodiment of the opening 28 that is sized and shaped to receive a jack. The opening 28 may have mounting apertures 29 positioned about the opening 28.

Slots 24, 26 may be formed in the top plate 16. The slots 24, 26 may extend in a direction substantially parallel to the first side 18 and the second side 20 as shown in FIG. 2B. In another embodiment, the slots 24, 26 may extend in a direction generally perpendicular to the first side 18 and the second side 20. For example, the slot 24 may extend toward the first side 18, and the slot 26 may extend toward the second side 20. The slots 24, 26 may abut and/or may be adjoined to the opening 28. The slots 24, 26 may separate the first portion 50 and the second portion 52 and may permit movement of the first portion 50 and the second portion 52. For example, the size, such as the length and the width of the slots 24, 26 may correspond to an amount of adjustment or movement possible for the first portion 50 and the second portion 52.

The opening 28 may be sized such that the jack mounting is preserved and a jack may be positioned therethrough. The opening 28 and/or the slots 24, 26 may be shaped such that movement of the sides 18, 20 and/or the portions 50, 52 limits any deflection to a specific location. For example, deflection caused from the movement of the sides 18, 20 and/or the portion 50, 52 may occur at or adjacent to the slots 24, 26. The sides 18, 20 and/or the portion 50, 52 may be moved or bent from the first position to the second position without deforming the attachment portion 14.

As shown in FIGS. 2A, 2B, and 4, the first portion 50 may be at a first angle B in an initial or unadjusted position with respect to the second portion 52. In an embodiment, the first angle B may be substantially equal to 50 degrees. As shown in FIGS. 5 and 6, the first portion 50 and/or the second portion 52 may be bent, adjusted, or otherwise moved to a second angle C. The first angle B may be greater than the second angle C. The first portion 50 may be movable or bendable with respect to the second portion 52 and vice versa without deformation of the attachment portion 14. The second angle C may be any angle that corresponds to the angle of the trailer frame 40 or may be any other predetermined angle as will be appreciated by a person having ordinary skill in the art.

The first portion 50 may be adjacent to the first side 18, and the second portion 52 may be adjacent the second side 20. The opening 28 may be positioned between the first side 18 and the second side 20. The first side 18 may move with the first portion 50, and the second side 20 may move with the second portion 52. The first side 18 may be positioned at the first angle with respect to the second side 20. The first side 18 and/or the second side 20 may be movable or bendable to the second angle C.

FIGS. 3-6 illustrate an embodiment of the trailer coupler 10 positioned on a trailer frame 40, such as the tongue of the trailer frame 40. The trailer coupler 10 may generally have a similar shape to the trailer frame 40. The trailer frame 40 may have a first leg 41 and a second leg 42 that extend together at an angle A. The angle A may be an angle different than a standard 50 degree trailer frame. For example, the angle A may be less than 50 degrees, such as 40 degrees.

The trailer coupler 10 may be positioned on the trailer frame 40. The attachment portion 14 may be positioned such that the attachment portion 14 abuts an end of the trailer frame 40. The top plate 16 may be positioned on the legs 41, 42 of the trailer frame 40. The first portion 50 and the second portion 52 may be aligned on the first leg 41 and the second leg 42 of the trailer frame 40, respectively. The first side 18 and the second side 20 may be separated a distance from the first leg 41 and the second leg 42. For example, the first leg 41 and the second leg 42 may be positioned at the second angle C. The first side 18 and the second side 20 may be at the first angle B. FIGS. 3 and 4 illustrate an embodiment of the trailer coupler 10 at the first position or at another position that requires adjustment in order to attach to the trailer frame 40.

The first side 18 and the second side 20 may be moved from the first position to the second position and/or from the first angle B to the second angle C. At the second position, the first side 18 and the second side 20 may abut and/or may contact the first leg 41 and the second leg 42. As illustrated in FIGS. 5 and 6, the first side 18 and/or the second side 20 may be moved to the second position, any other position that corresponds to the trailer frame 40, or such other position in which the first side 18 and the second side 20 contact the legs 41, 42 of the trailer frame 40.

The opening 28 and/or the slots 24, 26 may decrease in size as the sides 18, 20 are moved toward each other. The opening 28 and/or the slots 24, 26 may increase in size as the sides 18, 20 are moved away from each other. Deflection that may occur upon movement of the sides 18, 20 and/or the portions 50, 52 may be directed to a predetermined location that may not deform the trailer coupler 10. For example, the slots 24, 26 and/or the opening 28 may direct any deflection to a position adjacent to the slots 24, 26 or the opening 28.

Clamps 200 or other device may move and/or may hold the first side 18 and the second side 20 at the second position as shown in FIGS. 5 and 6. The trailer coupler 10 may be attached to the trailer frame 40 at the second position. For example, the attachment portion, the first side 18, and the second side 20 may be welded or otherwise attached to the trailer frame 40. The trailer coupler 10 is preferably welded to the trailer frame 40, however the invention is not limited to any specific manner of attaching the trailer coupler 10 to the trailer frame 40.

In an embodiment, the attachment portion 14 and/or the top plate 16 may be tack welded or otherwise attached to the trailer frame 40 prior to moving the sides 18, 20 and/or the portions 50, 52. In such an embodiment, the sides 18, 20 may be adjusted, bent or otherwise moved to a shape corresponding to the shape of the trailer frame 40. Attaching the attachment portion 14 and/or the top plate 16 prior to adjusting, bending or otherwise moving the sides 18, 20 may provide a pivot point in which to move the sides 18, 20 and/or the portions 50, 52. The sides 18, 20 and/or the portion 50, 52 may be attached and/or secured to the trailer frame 40 at the second position and/or the second angle C.

In use, the sides 18, 20 and the portions 50, 52 may be at the first position at the first angle B. The trailer coupler 10 may be positioned on the trailer frame 40 such that the portions 50, 52 extend on the legs 41, 42 of the trailer frame 40. The attachment portion 14 and the top plate 16 may be positioned on the trailer frame 40 and may be attached or secured to the trailer frame 40, such as by tack welding. At the first position, the sides 18, 20 may be separated from the legs 41, 42 of the frame 40 by a distance. The portions 50, 52 and/or the sides 18, 20 may be moved to the second position or such position that one or both of the sides 18, 20 contact the trailer frame 40. The portions 50, 52 may be clamped or otherwise held into position on and/or against the trailer frame 40, such as by use of the clamps 200. The portions 50, 52 and/or the sides 18, 20 may be attached to and/or secured to the trailer frame 40, such as by welding to the trailer frame 40 at the second position and/or the second angle C.

The trailer coupler 10 may be secured to the towing vehicle. For example, the attachment portion 14 may be secured to a hitch ball that is secured to the towing vehicle. To this end, the towing vehicle may transport the trailer frame 40 by use of the trailer coupler 10.

The embodiment of the invention has been described above and, obviously, modifications and alternations will occur to others upon reading and understanding this specification.

The claims as follows are intended to include all modifications and alterations insofar as they come within the scope of the claims or the equivalent thereof.

Having thus described the invention, the following is claimed:

1. A trailer coupler comprising:
an attachment portion shaped to receive a hitch ball; and
a top plate having a first portion and a second portion, the first portion and the second portion forming a first angle at a first position, wherein the first portion and the second portion are movable to a second position to form a second angle that is different than the first angle.

2. The trailer coupler of claim 1 further comprising:
a slot or an opening separating the first portion from the second portion.

3. The trailer coupler of claim 1 further comprising:
a first slot in the top plate defining the first portion.

4. The trailer coupler of claim 3 further comprising:
a second slot in the top plate defining the second portion.

5. The trailer coupler of claim 4 wherein the first slot and the second slot separate the first portion from the second portion such that the first portion is movable with respect to the second portion.

6. The trailer coupler of claim 1 wherein the second angle is less than the first angle.

7. The trailer coupler of claim 1 wherein the top plate is shaped for attachment to an A-frame of a trailer.

8. The trailer coupler of claim 1 wherein the first portion and the second portion are bendable without deforming the attachment portion of the trailer coupler.

9. The trailer coupler of claim 1 wherein deflection of the top plate from movement of the first portion and the second portion from the first position to the second position occurs at a predetermined location without deforming the attachment portion.

10. The trailer coupler of claim 1 wherein the first portion and the second portion are attachable to a trailer frame at the first position.

11. The trailer coupler of claim 1 wherein the first portion and the second portion are attachable to a trailer frame at the second position.

12. The trailer coupler of claim 1 wherein the second angle is less than 50 degrees.

13. The trailer coupler of claim 1 wherein the first angle is substantially equal to 50 degrees.

14. A trailer coupler comprising:
an attachment portion capable of connection to a towing vehicle;
a top plate extending from the attachment portion; and
a first side and a second side positioned at opposing sides of the top plate, the first side at a first angle with respect to the second side, wherein the first side or the second side is movable to form a second angle that is different than the first angle.

15. The trailer coupler of claim 14 wherein the top plate has an opening formed between the first side and the second side.

16. The trailer coupler of claim 15 wherein the top plate has at least two slots defining a first portion and a second portion of the top plate.

17. The trailer coupler of claim 16 wherein the first side is adjacent the first portion and the second side is adjacent the second portion.

18. A method of securing a trailer coupler to a trailer frame comprising the steps of:
providing a trailer coupler having a top plate and an attachment portion, the trailer coupler having a first side at a first angle with respect to a second side;
securing the attachment portion to the trailer frame;
moving at least one of the first side or the second side to a second angle that corresponds to an angle of the trailer frame; and
attaching the trailer coupler to the trailer frame.

19. The method of claim 18 further comprising the step of:
clamping the first side and the second side of the trailer coupler to the trailer frame prior to attaching the trailer coupler to the trailer frame.

20. The method of claim 18 wherein the top plate has a first slot and a second slot that separate a portion of the first side from a portion of the second side such that the portion of the first side is movable with respect to the second side.
